(19) United States
(12) Patent Application Publication
(10) Pub. No.: US 2025/0200631 A1
(43) Pub. Date: Jun. 19, 2025

(54) SYSTEM AND METHOD FOR PROVIDING REAL TIME RECOMMENDATIONS FOR MULTIPLE TASKS

(71) Applicant: Verizon Patent and Licensing Inc., Basking Ridge, NJ (US)

(72) Inventors: Cangcheng Tang, Waltham, MA (US); Luyang Wang, Upper Saddle River, NJ (US)

(73) Assignee: Verizon Patent and Licensing Inc., Basking Ridge, NJ (US)

(21) Appl. No.: 18/541,469

(22) Filed: Dec. 15, 2023

(51) Int. Cl. G06Q 30/0601; G06F 9/451

(52) U.S. Cl. CPC G06Q 30/0631; G06F 9/451

(57) ABSTRACT

The present teaching relates to recommendation. Current event information and historic sequence data are received. The former characterizes a current event involving a user and user's interactions with a user interface (UI). The latter includes UIs and corresponding user interactions thereon with corresponding performance data. A task sentence is created with multiple tokens, each of which corresponds to a task. The current event information, the historic sequence data, and the task sentence are used for predicting a next item to be recommended via a mixture of expert (MoE) prediction model, trained via multi-task learning. The next item is recommended to the user on the UI.

### BACKGROUND

Recommending content to a user, whether it is an article or a product/service in an online setting has become quite popular. Data related to users including their content consumption habits and activities performed in different contexts may be utilized to train a model for recommending different content to different users in different contexts. Such data may be used to train a model that provides recommendations with optimized performance as characterized by corresponding performance metrics such as click-through rate (CTR) or conversion rate (CVR).

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1A provides a webpage as an example of a user interface (UI) with different sections some of which display recommended content;

FIG. 1B shows an example webpage with specific products recommended in different sections;

FIG. 2A depicts an exemplary high-level system diagram of a framework for adaptively recommending content on a webpage based on mixture of experts (MoE) prediction models, in accordance with an embodiment of the present teaching;

FIG. 2B is a flowchart of an exemplary process of a framework for adaptively recommending content on a webpage based on MoE prediction models, in accordance with an embodiment of the present teaching;

FIG. 3A shows exemplary types of information related to a current event occurring with respect to a webpage, in accordance with an embodiment of the present teaching;

FIG. 3B illustrates exemplary types of information included in sequence related data, in accordance with an embodiment of the present teaching;

FIG. 3C shows different types of embeddings provided to MoE prediction models as input, in accordance with an embodiment of the present teaching;

FIG. 3D illustrates the concept of a task sentence that may be dynamically constructed as a combination of a flow and a goal, in accordance with an embodiment of the present teaching;

FIG. 4A depicts an exemplary high level system diagram of a next item recommendation engine, in accordance with an embodiment of the present teaching;

FIG. 4B shows an exemplary process of generating embeddings of different types of relevant data as input to MoE prediction models for content recommendation, in accordance with an embodiment of the present teaching;

FIG. 4C is a flowchart of an exemplary process of a next item recommendation engine, in accordance with an embodiment of the present teaching;

FIG. 5A illustrates an exemplary multi-layer construct of MoE prediction models, in accordance with an embodiment of the present teaching;

FIG. 5B shows an exemplary implementation of MoE prediction models using artificial neural networks (ANN), in accordance with an embodiment of the present teaching;

FIG. 6 is an illustrative diagram of an exemplary mobile device architecture that may be used to realize a specialized system implementing the present teaching in accordance with various embodiments; and

FIG. 7 is an illustrative diagram of an exemplary computing device architecture that may be used to realize a specialized system implementing the present teaching in accordance with various embodiments.

### DETAILED DESCRIPTION OF EXAMPLE EMBODIMENTS

In the following detailed description, numerous specific details are set forth by way of examples in order to facilitate a thorough understanding of the relevant teachings. However, it should be apparent to those skilled in the art that the present teachings may be practiced without such details. In other instances, well known methods, procedures, components, and/or system have been described at a relatively high-level, without detail, in order to avoid unnecessarily obscuring aspects of the present teachings.

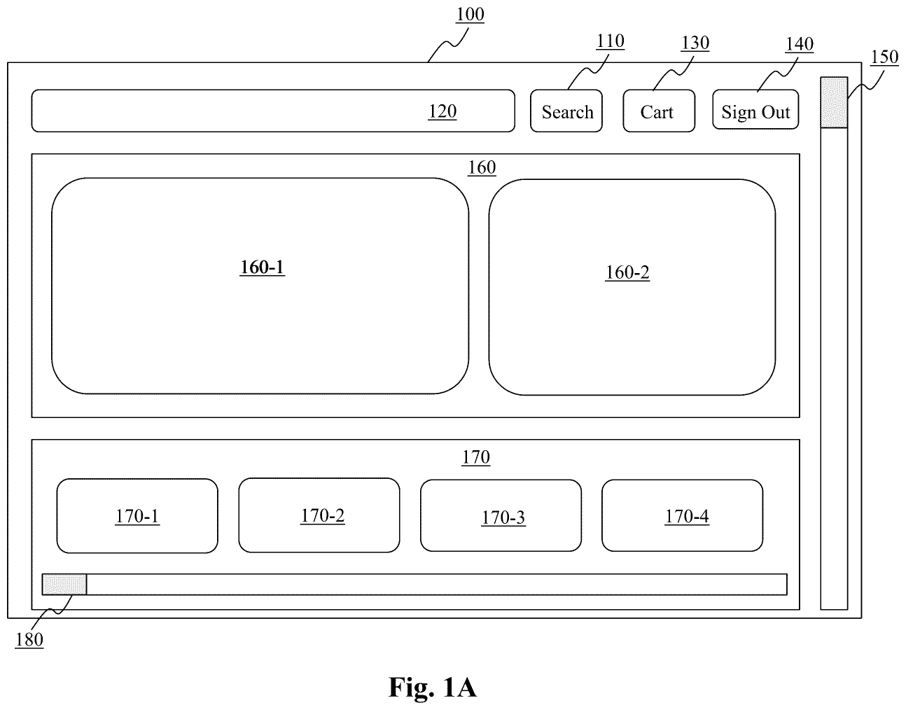

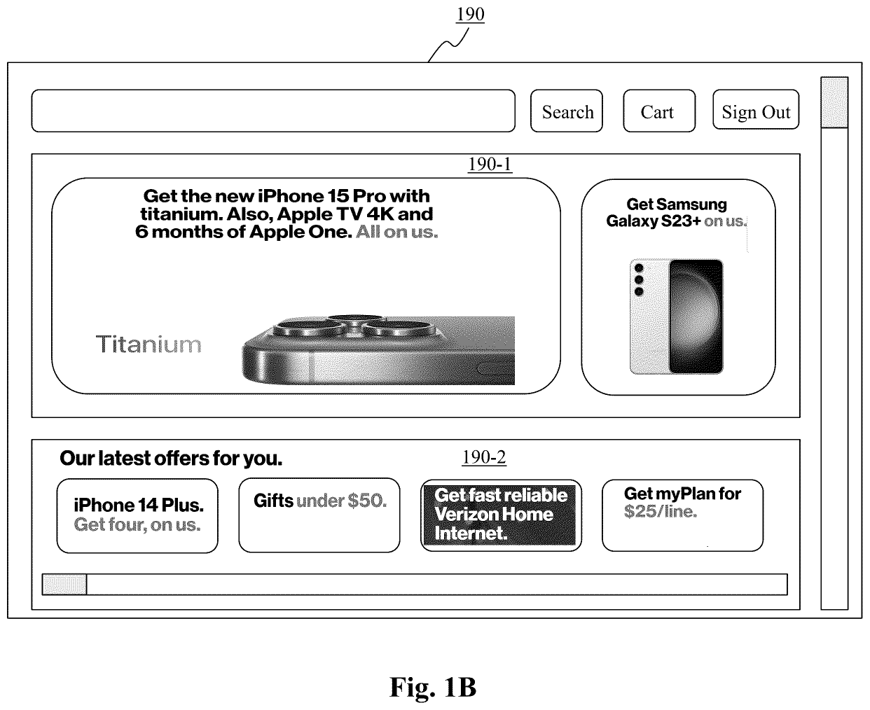

The present teaching is directed to a framework of using multi-task learning (MTL) scheme in the context of content recommendation. The MTL scheme enables sharing of information across different tasks to improve the accuracy of recommendations across different tasks. Such a scheme may be applied to facilitate learning of mixture-of-experts (MoE) for content recommendation. In some recommender systems (RS), the recommendation task corresponds to a next-item prediction problem, where the goal is to predict the next item to be recommended given known historic user behavior with a user interface (UI, e.g., a webpage or the like) and contextual information in a manner to optimize the recommendation with respect to some performance metrics. It is noted that a user interface may include any form of platform by which a user may interact therewith to receive information, provide information, or deliver actions. Examples of a user interface may include, without limitation, a webpage, an application, an interface displayed on a device including both a mobile and a stationary device. Throughout this disclosure, any reference to any form of a user interface (e.g., a webpage) is to be provided as an example and may be applied to any other form of user interface. FIG. 1A provides an webpage 100 with different sections as an exemplary user interface. As stated herein, any other form of user interface may be used. As illustrated, the exemplary webpage 100 may provide search capability (a search region 120 for entering search words and a search button 110 to activate the search), a cart 130 for items to be purchased, a sign-out button 140 for exiting the webpage, a vertical scroll button 150, and a horizontal scroll button 180. There are two sections on exemplary webpage 100, including a section 160 and a section 170, each of which may includes sub-sections (e.g., section 160 includes 160-1 and 160-2 and section 170 includes subsections 170-1 to 170-4). Each of the subsections may be designated for displaying certain categories of content. Some sections may display recommended content such as predicted next items given the context.

FIG. 1B shows an example UI in the form of a webpage 190 associated with, e.g., a telecommunication service provider, with specific items and products displayed in different sections/subsections of the webpage. As shown, the example webpage 190 has a section 190-1, which displays recommended smart phone products, including the new products and associated offers recommended, e.g., in connection with the new products displayed in section 190-1. The content on the webpage may change dynamically based on, e.g., the activities of a user interacting with the page (e.g., scrolling up and down the page or dwell time at certain position of the page), the existing items in the cart (indicative of intent of purchasing), and/or the information known about the user. Whenever the content on the webpage 190 is to be changed, dynamic content may be modified, e.g. the next item in each/some of the subsections of the webpage. For example, if the user scrolls the webpage to the right (moving the horizontal scroll button to the right) to see more recommended options of products (in addition to the iPhone 15 Pro and the Samsung Galaxy S23+), the next item recommended in the “latest offers” section may also be dynamically recommended accordingly.

Predicting the next item may be achieved based on an MoE model that may be trained to optimize some dynamically configured performance metrics, such as click through rate (CTR), add to cart rate (ATC), conversion rate (CVR), etc. The performance metrics to be optimized may differ depending on the context and specific scenarios. For example, predicting which smartphone a user will purchase next can be framed as an optimization problem with respect to a CVR task. In a different situation, the optimization criterion may be defined as a CTR task. Thus, next-item recommendation prediction may correspond to a multi-task optimization problem and may dynamically optimize against whatever is configured on-the-fly. In addition, such a multi-task recommender system may be trained to be able to automatically switch to one or more relevant experts whenever the optimization criterion changes under different scenario. Furthermore, the mixture of experts (MoE) models and their interactions are trained simultaneously, each learning individual expertise and all learning how to interact with each other to optimize with respect to dynamic performance metrics.

The present teaching discloses a recommendation framework based on MoE prediction models obtained via multi-task learning and capable of automatically routing dynamically configured task sentences to relevant experts to optimize the recommendation according to performance metrics specified in the task sentences. According to the present teaching, information about past events, past event contexts, past user performances against different performance criteria, and past sequence information are collected and used to obtain embeddings for encoding different types of information and to train, via machine learning, MoE prediction models. With the learned embeddings and the trained MoE prediction models, when a user interacts with a webpage, a next item may be recommended through prediction based on, e.g., information about the current event, the contextual information, as well as a task sentence indicative of the performance metrics to be optimized. In some embodiments, a task sentence may be a combination of a flow (flow on the UI) and a goal (performance to be optimized) and may be generated on-the-fly based on the gain to be maximized at the time of the recommendation.

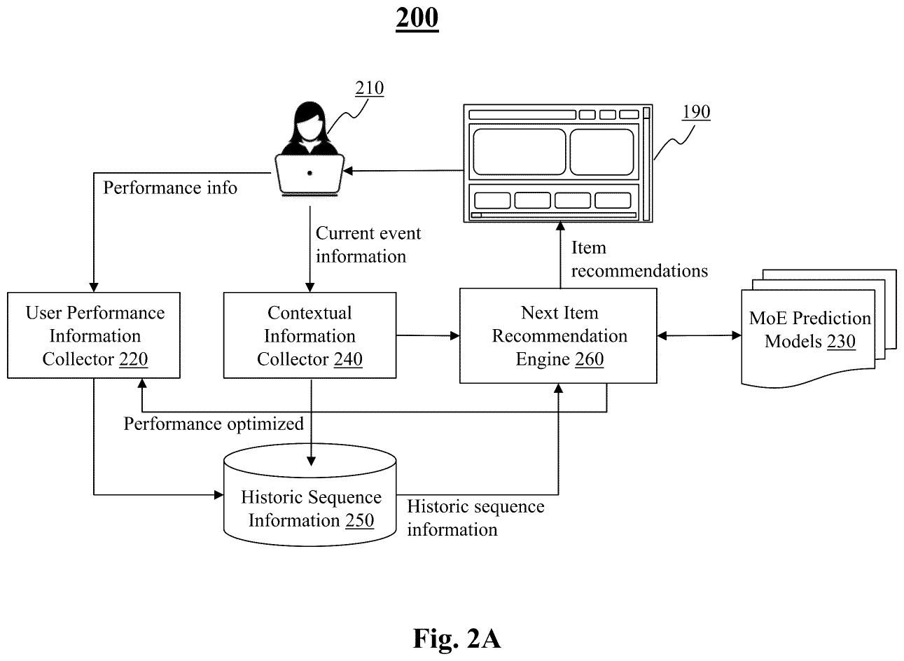

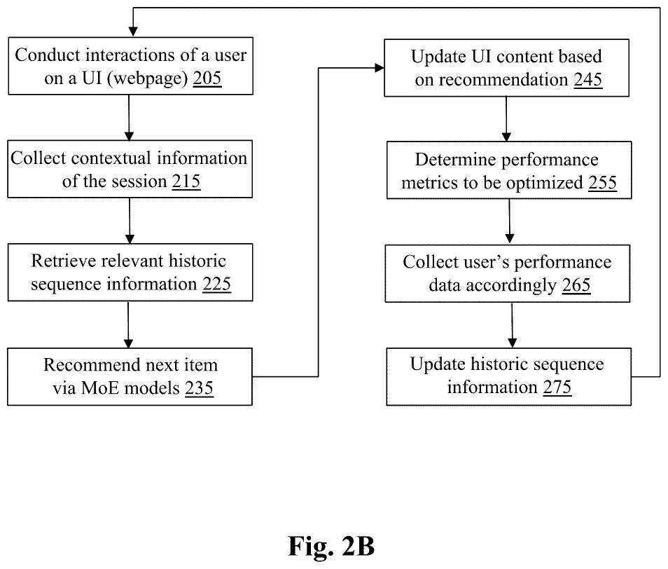

FIG. 2A depicts an exemplary high-level system diagram of a framework 200 for recommending content on a webpage based on MoE prediction models by optimizing based on task sentences generated on-the-fly, in accordance with an embodiment of the present teaching. In this illustrated content recommendation framework 200, users 210 may interact with webpages (e.g., 190) and yield performance data. Such performance data as the contextual information associated with the users' interactions are collected by a user performance information collector 220 and a contextual information collector 240, respectively and used to generate historic sequence information 250. Such historic sequence information with contextual and performance data may be utilized by a next item recommendation engine 260 to train, via multi-task learning, MoE prediction models 230 through machine learning. Such machine learned MoE prediction models 230 may then be used for predicting next item(s) to be recommended on the webpage 190 to the user 210 based on, e.g., information about the current event associated with the user and the webpage as well as at least one task sentence dynamically generated for performance optimization.

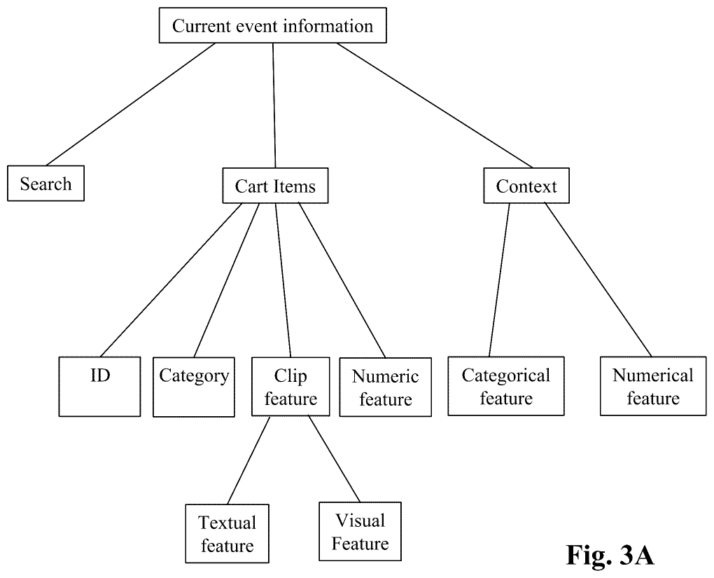

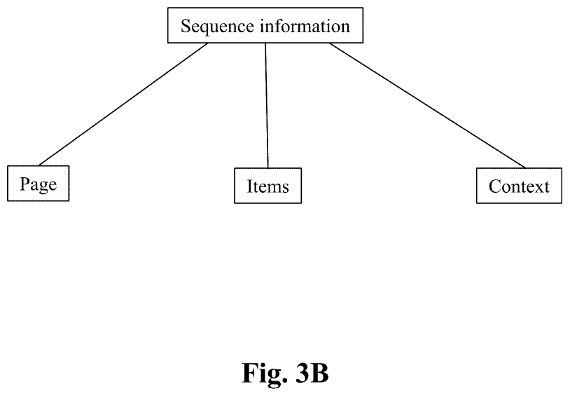

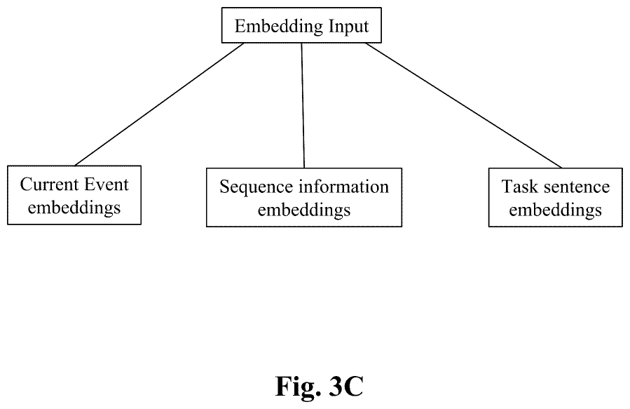

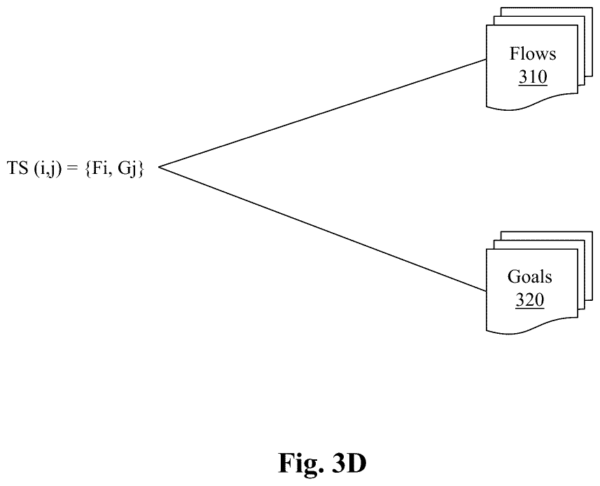

The predicted next item(s) may then be displayed on the webpage 190 in one or more portions of the UI. User reactions to/interactions with the recommended item may be monitored to determine the performance data with respect to each recommended item as well as the contextual information. The performance and contextual information for each of the recommended items may be continuously collected and used to update the historic sequence information stored in 250. The updated historic sequence data may then be used, when needed, for updating the MoE prediction models 230 by, e.g., retraining or performing adaptive incremental training of the MoE prediction models 230. In this manner, the MoE predictive models 230 may adapt to the dynamics of the context data and each of the experts in the MoE prediction models 230 may behave in accordance with the changing context data. Details about obtaining the MoE prediction models 230 and use thereof for predicting next item to be recommended are provided with reference to FIGS. 3A-5B.

FIG. 2B is a flowchart of an exemplary process of framework 200 for recommending next item(s) on a UI based on MoE prediction models that optimizes dynamically specified performance metrics, in accordance with an embodiment of the present teaching. When information is received about interactions of a user on a UI at 205 in a session, the contextual information collector 240 collects, at 215, contextual information associated with the session and provides to the next item recommendation engine 260. Different types of information associated with the event occurred in the session may be collected. FIG. 3A shows exemplary types of information related to a current event occurring in a session with respect to a webpage, in accordance with an embodiment of the present teaching. As illustrated, information associated with a current event may include the search(es) that the user conducted because searches may indicate certain intent or interests of the user.

Information related to item(s) that the user placed in the cart may also be relevant to what is the next item to be recommended because information about the items in the cart may be indicative of the intent or interests of the user. Information related to the interested items (e.g., items that were placed in an electronic cart) may include, but is not limited to, the identification of the interested items, category of each item, and information about each item, such as textual and/or visual description about the item, and may be some numeric features of each item such as a ranking, etc. Additional information collected may also include context of the session. Such contextual information may be related to some categorical feature, e.g., the content on current webpage may be related to smart phone, which is in the category of, e.g., devices, or some numerical feature such as, e.g., smart phone's price ranges.

To make a recommendation for a next item to the user on the webpage 190, the next item recommendation engine 260 also retrieves, at 225, relevant historic sequence information collected previously in 250. In making recommendations of next items on a webpage based on the dynamics of user interactions with the webpage, information related sequences of events may be relevant. For example, sequence information may provide important data about on which webpage, what items are often desired with respect to what context may constitute relevant sequences which may be used to determine what next item to be recommended based on a current webpage with a current context with certain known items on the webpage or currently in the cart. Thus, different type of data associated with different sequence may be continuously gathered from different sessions involving different users and different webpages, as illustrated in FIG. 3B, in accordance with an embodiment of the present teaching.

Based on information related to the current context of the session as well as the historic sequence information representing the users' behavior, the next item recommendation engine 260 recommends, at 235, at least one next item based on the MoE prediction models 230. As discussed herein, the MoE prediction models 230 may be previously trained via multi-task learning based on historic contextual information. Each recommended next item may then be used to update, at 245, the content on the webpage so that the next item is presented to the user.

Once the recommendation of next item(s) presented to the user, the user's performance is monitored so that desired performance data may be collected and utilized to adapt the MoE prediction models 230. To do so, the user performance information collector 220 determines, at 255, the performance metrics to be optimized so that it may then proceed to collect, at 265, the user's performance data accordingly. Such collected user's performance data is then used to update, at 275, the historic sequence information in 250 so that the next item recommendation engine 260 may utilize to adapt the MoE prediction models 230 to the dynamics observed to adaptively make the next recommendations.

As discussed herein, the next item recommendation engine 260 predicts a recommendation of a next item based on the contextual information related to the current session and the historic sequence information in accordance with the MoE prediction models 230. In some embodiments, information to be utilized to make a recommendation may be processed to generate embeddings for characterizing the information which may then be input to the MoE prediction models 230 to produce outputs corresponding to the recommendations. Different embeddings may be applied to different types of information and may be obtained via machine learning. FIG. 3C shows exemplary types of embeddings for characterizing different types of information for MoE prediction model based next item recommendation, in accordance with an embodiment of the present teaching. In this illustration, embeddings input to the MoE prediction models include embeddings generated for information related to the current event in a session, embeddings created for historic sequence information, and embeddings characterizing the task sentence(s) dynamically generated for each recommendation. These embeddings may be learned during training and the learnable parameters for obtaining the embeddings are adjusted during the training so that the resultant embeddings characterize the input information in such a way that provides the basis to certain recommendation decisions.

As discussed herein, the MoE prediction models 230 may be learned via multi-task learning so that multiple experts may be trained. In the multi-task learning scheme, individual experts obtained via multi-task learning may be trained to possess useful capabilities that enable improved performance in content recommendation. For example, while individual experts in the mixture of experts (MoE) may be trained to optimize recommendation with respect to respective targeted performance metrics (different tasks), they may also be trained to consider mutual influences or inferences between different experts, allowing the learned model to optimize across multiple tasks.

There are some commonly known issues associated with a conventional multi-task learning (MTL) scheme. For example, scaling challenges exist in existing MTL architectures because training and inference speeds may degrade rapidly when the number of tasks increases. In some situations, multiple single-task recommendation system may be developed, each of which may be trained to perform a single task to optimize recommendation against a respective performance metric. Models working in isolation fail to consider the interconnection among various use cases, resulting in a narrow model vision and potential recommendation bias. In addition, training data is generally sparse for individual respective tasks, such as CVR-related tasks. Insufficient training data also presents challenges for obtaining models with large numbers of parameters to optimize. Furthermore, maintaining multiple single-task recommenders generally increases the complexity of coordinating machine learning of individual single-task models.

To overcome these challenges, the MoE prediction models 230 according to the present teaching is provided to facilitate a general recommender framework that can handle multiple recommendation tasks simultaneously based on a sparse mixture-of-experts (sparse MoE) architecture. This structure is capable of having a subset of expert layers activated depending on task categories, which allows multiple tasks to be combined and trained in one model. In addition, the present teaching discloses the concept of a task-sentence, the construction thereof, as well as a routing mechanism for automatically routing a given task-sentence to relevant experts in the MoE architecture. The task-sentence allows more efficient scalability, and its dynamic construction on-the-fly enables switches among different recommendation optimization criteria. The routing strategy may also be learned during training, making it possible for the MoE prediction models 230 to expand its capacity for cross-task generalization while maintaining inference-based performance enhancement.

FIG. 3D illustrates an exemplary construct of a task-sentence that may correspond to a combination of a flow and a goal, in accordance with an embodiment of the present teaching. As shown therein, a task-sentence TS (i,j) may be formed to include different tasks, each having a specified flow, i.e., Fi, and a specified goal, i.e., Gj, where Fi may be selected from a group of possible flows 310 and Gj may be selected from a set of specified goals 320 according to some target performance. In some embodiments, the specific flows specified in 310 may be defined according to the application situation. For example, when applying the present teaching to telecommunication related services, digital interactions with customers may typically follow flows such as (1) adding a line to an existing account (AAL), (2) upgrading current devices (EUP), and (3) prospect customers' acquisition of new services (NSE). On the other hand, the goals defined in 320 may be specified as target business goals, such as CTR and CVR.

Pairing individual task types may create excessive number of different tasks, and such splits may introduce imbalance of training the dataset and lead to weakly trained models. The concept of task-sentence according to the present teaching may also allow combinations of multiple task tokens into a sentence so that expert routing may be performed at a task-sentence level. For example, different flows (e.g., EUP, AAL) and different goals (e.g., CTR, CVR) may be combined as a task sentence (e.g., AAL+CVR, EUP+CTR) which may then be routed as a whole at the task sentence level. With this approach, even with many flows and goals, there may be a manageable number of types of task-sentences.

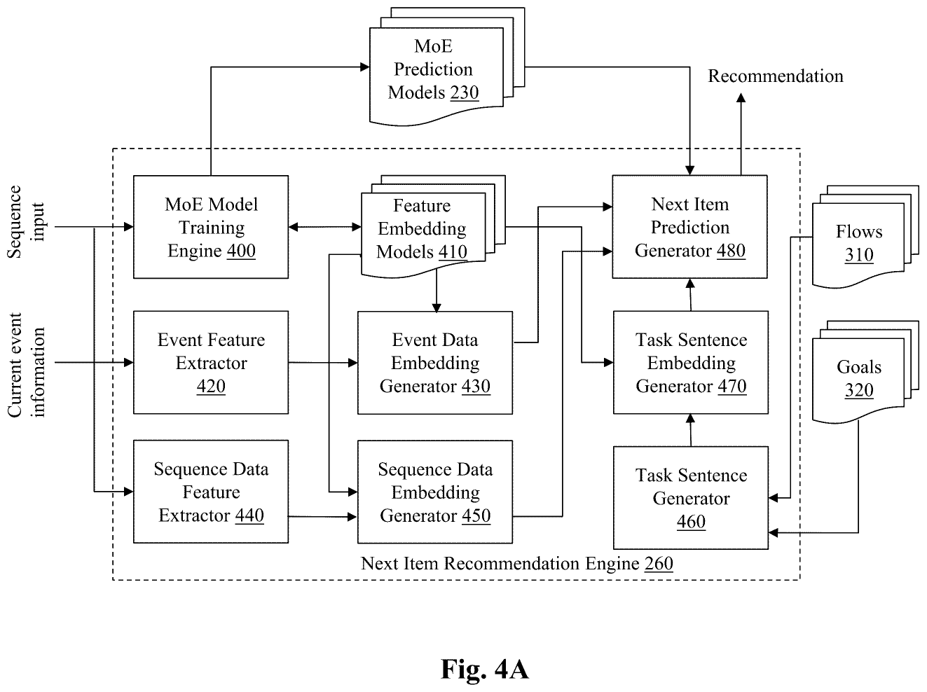

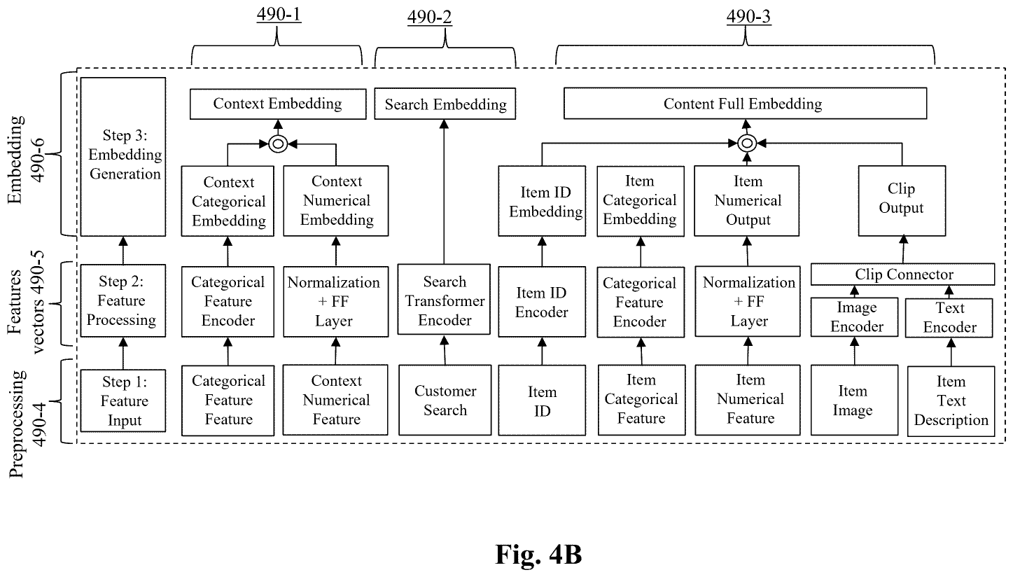

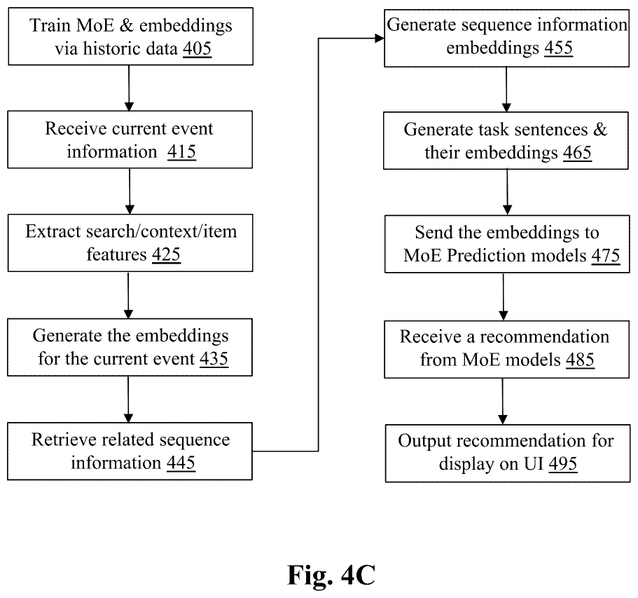

FIG. 4A depicts an exemplary high level system diagram of the next item recommendation engine 260, in accordance with an embodiment of the present teaching. In this illustrated embodiment, the next item recommendation engine 260 includes two parts. The first part is provided for training, via machine learning, the MoE prediction models 230 as well as various embeddings models 410. With the trained MoE prediction models 230 and the embeddings 410, the second part is for generating a recommendation of a next item to be displayed on a webpage based on input associated with an interaction session with a user based on the learned embeddings the MoE prediction models 230. The first part includes an MoE model training engine 400 that takes the historic sequence information as training data from storage 250 and performs machine learning based on the training data to obtain embeddings models 410 as well as the MoE prediction models 230. In some embodiments, the historic sequence information stored in 250 may incorporate contextual information collected previously with respect to each past event as well as performance data collected with respect to recommended items.

The trained embeddings models 410 and MoE prediction models 230 may then be used in the second part to predict a next item recommendation on a webpage when different types of input information are received such as current event information and the historic sequence data. The current event information may describe an interaction session on the webpage involving a user, such as the interactions (e.g., search performed), the contextual information related to the sessions, and information about the items that are currently placed in the user's cart, as illustrated in FIG. 3A. In addition, historic sequence information may also be considered in making a next item recommendation as such data characterizes past behaviors/performances. Furthermore, to optimize a next item recommendation with respect to an intended goal, a task sentence may be dynamically created to specify some optimization criterion according to the present teaching so that the recommendation task may be routed automatically to relevant experts in the MoE.

In the illustrated embodiment as shown in FIG. 4A, the second part of the next item recommendation engine 260 comprises an event feature extractor 420, an event data embedding generator 430, a sequence data feature extractor 440, sequence data embedding generator 450, a task sentence generator 460, a task sentence embedding generator 470, and a next item predictor generator 480. The event feature extractor 420 may be provided to process the current event information to obtain features for different types of event information. Based on such extracted feature vectors, the event data embedding generator 430 may be provided to generate embeddings for different types of current event information in accordance with the trained feature embedding models 410.

FIG. 4B shows an exemplary construct of generating embeddings for different types of current event information, in accordance with an embodiment of the present teaching. In this illustration, the current event information includes contextual information 490-1, search information 490-2, and interested items 490-3. Each type of information as illustrated herein may be processed in different stages to produce embeddings for the current event information as input to the MoE prediction models 230. In some embodiments, exemplary different stages may include a preprocessing stage 490-4 (e.g., to classify information into different categories), a feature vector generation stage 490-5 (e.g., to generate feature vectors for each type of event information), and an embedding stage 490-6 (e.g., to produce embeddings for each type of event information). The first two stages of processing may be performed by the event feature extractor 420 and the third stage of embedding processing may be performed by the event data embedding generator 430.

Similarly, historic sequence data may also be processed to produce its embeddings as input to the MoE prediction models 230. As such, the sequence data feature extractor 440 may process input sequence data and extract relevant feature vectors, which may then be used by the sequence data embedding generator 450 to obtain embeddings for the input sequence data. The task sentence generator 460 is provided to generate a task sentence with flow and goal combinations and embeddings for such a task sentence may then be generated by the task sentence embedding generator 470 based on the trained embedding models 410. With different types of embeddings created according to the present teaching, the next item prediction generator 480 operates to provide such embeddings to the MoE prediction models 230 and receive outputs therefrom. In some embodiments, the output predicted recommendations from the MoE prediction models 230 may be multiple, each may be from an expert with a confidence score. In some embodiments, the MoE prediction models 230 may output a single recommendation selected from multiple candidate recommendations via optimization based on given task sentence.

FIG. 4C is a flowchart of an exemplary process of the next item recommendation engine 260, in accordance with an embodiment of the present teaching. With historic sequence information collected as training data, the MoE model training engine 400 trains, at 405, the feature embedding models 410 as well as the MoE prediction models 230. In using such trained models for next item recommendation, when current event information is received at 415, the event feature extractor 420 extracts, at 425, different types of event related information and features thereof, which are then used by the event data embedding generator 430 to generate, at 435, the embeddings for respective different types of current event information. The sequence data feature extractor 440 retrieves, at 445, relevant sequence data and extracts the features thereof, which are then provided to the sequence data embedding generator 450 for generating, at 455, embeddings for the sequence data. The task sentence generator 460 may generate, at 465, task sentences by selecting appropriate flows and goals and combining according to, e.g., specification defined according to application needs. Embeddings for the dynamically formed task sentences may then be generated based on the trained embedding models 410.

As discussed herein, embeddings for different types of information (current event information, sequence data, and task sentence(s)) created based on the trained feature embedding models 410 are used as input to the MoE prediction models 230. The next item prediction generator 480 receives such embeddings from the event data embedding generator 430, the sequence data embedding generator 450, and the task sentence embedding generator 470 and provides to the MoE prediction models 230 to yield output next item recommendation(s). When the output next item recommendation(s) are received, at 485, a final recommendation may then be determined and output at 495.

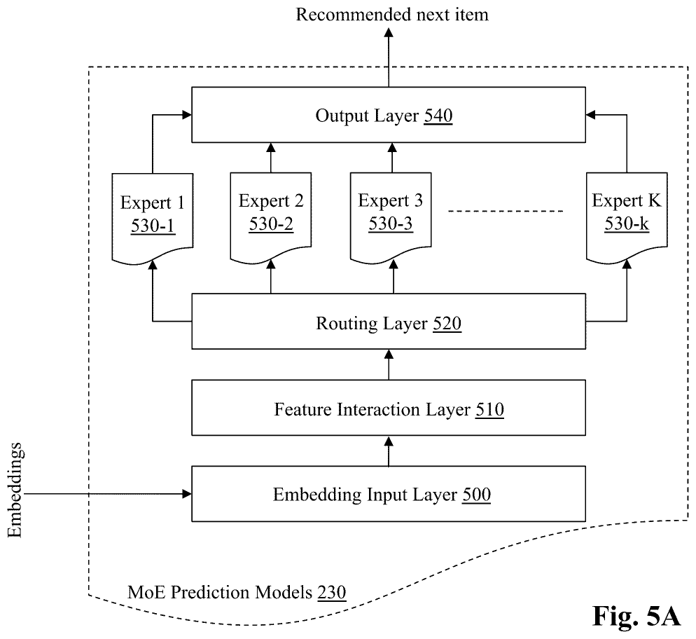

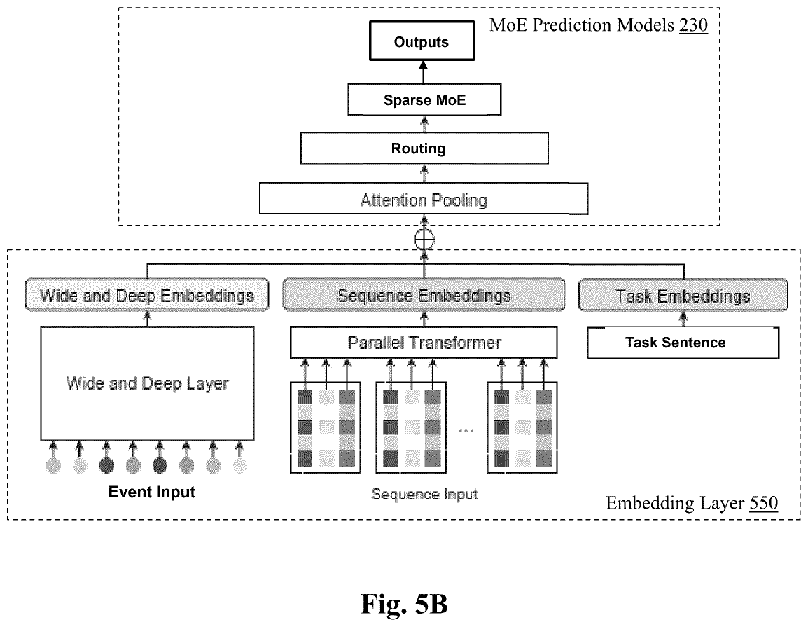

In some embodiments, the MoE prediction models 230 may be structured as a multi-layer construct with each layer trained for certain functionalities. FIG. 5A illustrates an exemplary multi-layer structure for the MoE prediction models, in accordance with an embodiment of the present teaching. In this exemplary structure, there are an embedding input layer 500, a feature interaction layer 510, a routing layer 520, a layer 530 for a mixture of experts (530-1-530-k) and an output layer 540. The exemplary multi-layer structured MoE prediction models 230 takes embeddings generated for different types of information (current event information, sequence data, and task sentences) as input and produces one or more recommendations for next items as output. In this embodiment, the embedding input layer 500 may be provided to process the input embeddings in different categories and provide separate groups of embeddings to the feature interaction layer 510.

The feature interaction layer 510 may be provided to learn the interactions among different categories of information. In some embodiments, input embeddings for a certain category of information (e.g., embeddings for current event information) may be modified based on input embeddings for input in a different category (e.g., embeddings for sequence data) and such modifications may be performed based on, e.g., knowledge about interactions between different types of information learned during training. The processed embeddings at the output of the feature interaction layer 510 may then be used by the routing layer 520 to route to different experts in the mixture of experts. In some embodiments, the routing may be implemented sending all embeddings to all experts but with different weights to each individual expert. Each of the experts may then process the routed embeddings (with weights) and produce its output which corresponds to a recommendation with, e.g., a confidence score. With the recommendations from different experts, the output layer 540 may output the MoE based predicted recommendation(s).

FIG. 5B shows an exemplary multi-layer artificial neural network (ANN) implementation of the MoE prediction models 230 and an embedding layer 550, in accordance with an embodiment of the present teaching. In this exemplary implementation, embeddings for current event information are generated via a wide and deep layer to produce wide and deep embeddings for different types of event related data (e.g., search, interested items, and context), the sequence data may be processed via a parallel transformer layer to produce sequence embeddings, and the task sentence may be represented by task embeddings separately.

In this illustrated embodiment, the ANN implementation of the MoE prediction models 230 may also comprise multiple layers, each of which may correspond to a subnet, including an attention pool layer, an ANN-based routing layer, a sparse MoE layer, and an output layer. The output embeddings from the embedding layer 550 may be provided to the attention pooling layer, which may be trained to modifying the input embeddings based on interactions among different types of information learned during training. As discussed herein, the subnet for the routing layer may be trained for routing embeddings to different relevant expert subnets based on the task sentences. The outputs from different expert subnets may then be consolidated or integrated at the output layer to produce output representing one or more recommendations.

Because the recommendation framework 200 according to the present teaching employs a sparse MoE architecture with the multi-task learning scheme with respect to task-sentences, it not only enhances the recommender's capability to generalize across multiple recommendation task categories but also improves the scalability of the MoE prediction models.

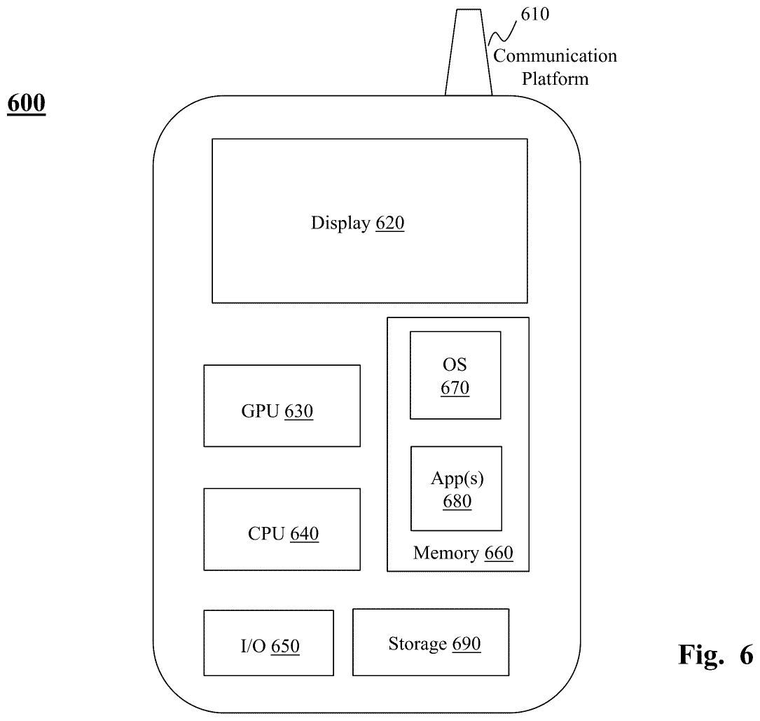

FIG. 6 is an illustrative diagram of an exemplary mobile device architecture that may be used to realize a specialized system implementing the present teaching in accordance with various embodiments. In this example, the user device on which the present teaching may be implemented corresponds to a mobile device 600, including, but not limited to, a smart phone, a tablet, a music player, a handled gaming console, a global positioning system (GPS) receiver, and a wearable computing device, or a mobile computational unit in any other form factor. Mobile device 600 may include one or more central processing units (“CPUs”) 640, one or more graphic processing units (“GPUs”) 630, a display 620, a memory 660, a communication platform 610, such as a wireless communication module, storage 690, and one or more input/output (I/O) devices 650. Any other suitable component, including but not limited to a system bus or a controller (not shown), may also be included in the mobile device 600. As shown in FIG. 6, a mobile operating system 670 (e.g., iOS, Android, Windows Phone, etc.) and one or more applications 680 may be loaded into memory 660 from storage 690 in order to be executed by the CPU 640. The applications 680 may include a user interface or any other suitable mobile apps for information exchange, analytics, and management according to the present teaching on, at least partially, the mobile device 600. User interactions, if any, may be achieved via the I/O devices 650 and provided to the various components thereto.

To implement various modules, units, and their functionalities as described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar with to adapt those technologies to appropriate settings as described herein. A computer with user interface elements may be used to implement a personal computer (PC) or other type of workstation or terminal device, although a computer may also act as a server if appropriately programmed. It is believed that those skilled in the art are familiar with the structure, programming, and general operation of such computer equipment and as a result the drawings should be self-explanatory.

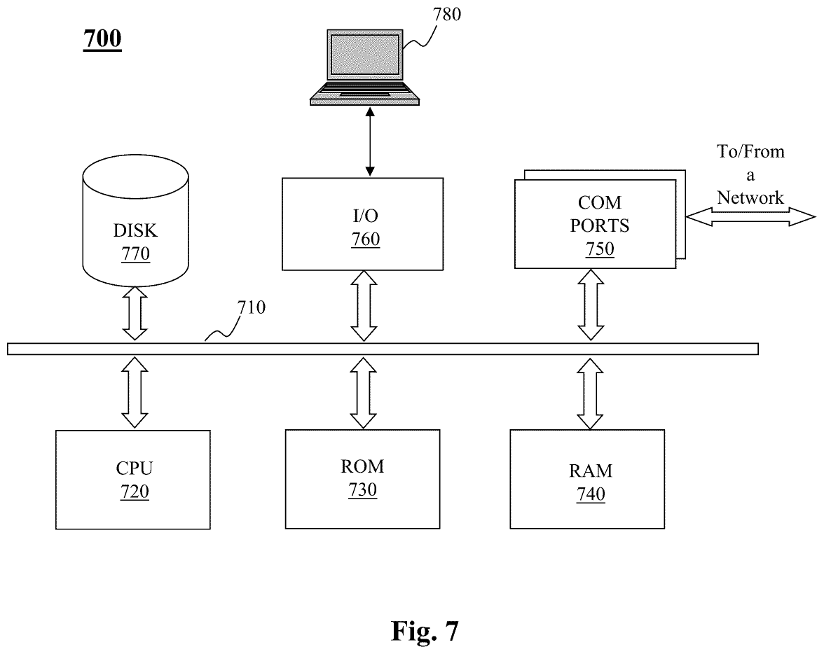

FIG. 7 is an illustrative diagram of an exemplary computing device architecture that may be used to realize a specialized system implementing the present teaching in accordance with various embodiments. Such a specialized system incorporating the present teaching has a functional block diagram illustration of a hardware platform, which includes user interface elements. The computer may be a general-purpose computer or a special purpose computer. Both can be used to implement a specialized system for the present teaching. This computer 700 may be used to implement any component or aspect of the framework as disclosed herein. For example, the information processing and analytical method and system as disclosed herein may be implemented on a computer such as computer 700, via its hardware, software program, firmware, or a combination thereof. Although only one such computer is shown, for convenience, the computer functions relating to the present teaching as described herein may be implemented in a distributed fashion on a number of similar platforms, to distribute the processing load.

Computer 700, for example, includes COM ports 750 connected to and from a network connected thereto to facilitate data communications. Computer 700 also includes a central processing unit (CPU) 720, in the form of one or more processors, for executing program instructions. The exemplary computer platform includes an internal communication bus 710, program storage and data storage of different forms (e.g., disk 770, read only memory (ROM) 730, or random-access memory (RAM) 740), for various data files to be processed and/or communicated by computer 700, as well as possibly program instructions to be executed by CPU 720. Computer 700 also includes an I/O component 760, supporting input/output flows between the computer and other components therein such as user interface elements 780. Computer 700 may also receive programming and data via network communications.

Hence, aspects of the methods of information analytics and management and/or other processes, as outlined above, may be embodied in programming. Program aspects of the technology may be thought of as “products” or “articles of manufacture” typically in the form of executable code and/or associated data that is carried on or embodied in a type of machine-readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, in connection with information analytics and management. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

It is noted that the present teachings are amenable to a variety of modifications and/or enhancements. For example, although the implementation of various components described above may be embodied in a hardware device, it may also be implemented as a software only solution, e.g., an installation on an existing server. In addition, the techniques as disclosed herein may be implemented as a firmware, firmware/software combination, firmware/hardware combination, or a hardware/firmware/software combination.

In the preceding specification, various example embodiments have been described with reference to the accompanying drawings. It will, however, be evident that various modifications and changes may be made thereto, and additional embodiments may be implemented, without departing from the broader scope of the present teaching as set forth in the claims that follow. The specification and drawings are accordingly to be regarded in an illustrative rather than restrictive sense.

We claim:

1. A method for recommendation, comprising:
receiving current event information characterizing a current event related to a communication session involving a user and the user's interactions with a user interface (UI);
retrieving historic sequence data related to a plurality of UIs and past user interactions directed thereto, wherein the historic sequence data includes performance data with respect to content recommended to the users and displayed on the plurality of UIs;
creating a task sentence with respect to the UI, wherein the task sentence has multiple tokens, each of which corresponds to a task;
generating embeddings, respectively, for the current event information, the historic sequence data, and the task sentence;
predicting, based on the embeddings via a mixture of expert (MoE) prediction model, a next item to be recommended to the user on the UI, wherein the MoE prediction model is previously trained via machine learning with multi-task learning; and
presenting the next item to the user on the UI.

2. The method of claim 1, wherein the MoE prediction model comprises a plurality of experts that are trained via the multi-task learning to gain respective expertise.

3. The method of claim 2, wherein the predicting the next item to be recommended to the user comprises:
receiving the embeddings as input;
generating modified embeddings based on the embeddings in accordance with knowledge learned during training on how different types of information interact;
routing the modified embeddings to at least some of the plurality of experts according to routing knowledge learned in training; and
processing recommendations from the at least some of the plurality of experts to determine the next item to be recommended to the user.

4. The method of claim 1, further comprising:
creating a next sequence data associated with the current event, including information about the UI, the current event information, and the next item recommended to the user;
incorporating new performance data related to the next item in the next sequence data obtained by monitoring the user's activity directed to the next item;
adding the new sequence data to the historic sequence data to generate updated historic sequence data; and
adapting the MoE prediction model via training using the updated historic sequence data.

5. The method of claim 1, wherein the current event information includes information related to at least one of:
searches conducted by the user during the communication session;
one or more items the user exhibits interest via the user's interactions on the UI; and
context of the current event.

6. The method of claim 1, wherein the historic sequence data includes a sequence of events, each of which includes a UI, contextual information, an item recommended on the UI given the context, and performance data associated with the recommended item.

7. The method of claim 1, wherein each of the tokens in the task sentence includes at least an item and a performance metric to be used to evaluate whether the user is to achieve a corresponding performance if the item is recommended to the user.

8. A machine-readable and non-transitory medium having information recorded thereon, wherein the information, when read by the machine, causes the machine to perform the following steps:
receiving current event information characterizing a current event related to a communication session involving a user and the user's interactions with a user interface (UI);
retrieving historic sequence data related to a plurality of UIs and past user interactions directed thereto, wherein the historic sequence data includes performance data with respect to content recommended to the users and displayed on the plurality of UIs;
creating a task sentence with respect to the UI, wherein the task sentence has multiple tokens, each of which corresponds to a task;
generating embeddings, respectively, for the current event information, the historic sequence data, and the task sentence;
predicting, based on the embeddings via a mixture of expert (MoE) prediction model, a next item to be recommended to the user on the UI, wherein the MoE prediction model is previously trained via machine learning with multi-task learning; and
presenting the next item to the user on the UI.

9. The medium of claim 8, wherein the MoE prediction model comprises a plurality of experts that are trained via the multi-task learning to gain respective expertise.

10. The medium of claim 9, wherein the predicting the next item to be recommended to the user comprises:
receiving the embeddings as input;
generating modified embeddings based on the embeddings in accordance with knowledge learned during training on how different types of information interact;
routing the modified embeddings to at least some of the plurality of experts according to routing knowledge learned in training; and
processing recommendations from the at least some of the plurality of experts to determine the next item to be recommended to the user.

11. The medium of claim 8, wherein the information, when read by the machine, further causes the machine to perform the following steps:
creating a next sequence data associated with the current event, including information about the UI, the current event information, and the next item recommended to the user;
incorporating new performance data related to the next item in the next sequence data obtained by monitoring the user's activity directed to the next item;
adding the new sequence data to the historic sequence data to generate updated historic sequence data; and
adapting the MoE prediction model via training using the updated historic sequence data.

12. The medium of claim 8, wherein the current event information includes information related to at least one of:
searches conducted by the user during the communication session;
one or more items the user exhibits interest via the user's interactions on the UI; and
context of the current event.

13. The medium of claim 8, wherein the historic sequence data includes a sequence of events, each of which includes a UI, contextual information, an item recommended on the UI given the context, and performance data associated with the recommended item.

14. The medium of claim 8, wherein each of the tokens in the task sentence includes at least an item and a performance metric to be used to evaluate whether the user is to achieve a corresponding performance if the item is recommended to the user.

15. A system, comprising:
a contextual information collector implemented by a processor and configured for receiving current event information characterizing a current event related to a communication session involving a user and the user's interactions with a user interface (UI);
a next item recommendation engine implemented by a processor and configured for
retrieving historic sequence data related to a plurality of UIs and past user interactions directed thereto, wherein the historic sequence data includes performance data with respect to content recommended to the users and displayed on the plurality of UIs,
creating a task sentence with respect to the UI, wherein the task sentence has multiple tokens, each of which corresponds to a task,
generating embeddings, respectively, for the current event information, the historic sequence data, and the task sentence, and
predicting, based on the embeddings via a mixture of expert (MoE) prediction model, a next item to be recommended to the user on the UI, wherein the MoE prediction model is previously trained via machine learning with multi-task learning; and
an operator of the UI implemented by a processor and configured for presenting the next item to the user on the UI.

16. The system of claim 15, wherein the MoE prediction model comprises a plurality of experts that are trained via the multi-task learning to gain respective expertise.

17. The system of claim 16, wherein the MoE prediction model comprises:
an input layer for receiving the embeddings as input;
a feature interaction layer trained for generating modified embeddings based on the embeddings in accordance with knowledge learned during training on how different types of information interact;
a routing layer trained for routing the modified embeddings to at least some of the plurality of experts according to routing knowledge learned in training;
an expert layer including the plurality of experts, each of which is to recommend an item to be recommended based on modified embeddings routed thereto; and
an output layer for processing items recommendations from the at least some of the plurality of experts to select the next item to be recommended.

18. The system of claim 15, further comprising a user performance information collector implemented by a processor and configured for
monitoring the user's activity directed to the next item to obtain new performance data related to the next item;
incorporating the new performance data in a next sequence data created for the current event, including information about the UI, the current event information, and the next item recommended to the user, wherein
the new sequence data is added to the historic sequence data to generate updated historic sequence data and the MoE prediction model is to be adapted via training using the updated historic sequence data.

19. The system of claim 15, wherein
the current event information includes information related to at least one of:
searches conducted by the user during the communication session,
one or more items the user exhibits interest via the user's interactions on the UI, and
context of the current event; and
the historic sequence data includes a sequence of events, each of which includes
a UI,
contextual information,
an item recommended on the UI given the context, and
performance data associated with the recommended item.

20. The system of claim 15, wherein each of the tokens in the task sentence includes at least an item and a performance metric to be used to evaluate whether the user is to achieve a corresponding performance if the item is recommended to the user.
